(19) United States
(12) Patent Application Publication
(10) Pub. No.: US 2002/0014201 A1
(43) Pub. Date: Feb. 7, 2002

(54) Device and method for spray extrusion

(76) Inventor: Michael Holmstrom, Finja (SE)

Correspondence Address: David D. Stein, Suite 1030, 250 E. Wisconsin Avenue, Milwaukee, WI, 53202, US

(21) Appl. No.: 09/877,394

(22) Filed: Jun. 7, 2001

(30) Foreign Application Priority Data
Dec. 8, 1998 (SE) PCT/SE99/02291
Dec. 8, 1999 (SE) 9804243-5

(51) Int. Cl. B05D 1/02; B05C 15/00

(52) U.S. Cl. 118/300; 427/421

(57) ABSTRACT

The invention relates to a device and a method for spray extrusion, more particularly for application of a surface coating “under-up” onto car bodies. The surface coating may be a PVC abrasion protection material, a joint sealant or the like, and is generally a low-viscosity material. The invention comprises a source of coating material connected to a nozzle for spraying the material onto an object. According to the invention, the nozzle has a discharge aperture in the form of a pattern of holes (5), preferably a row of holes. Through this reduction of the discharge area, a raised pressure is created in the nozzle, causing the material to be sprayed out of the nozzle onto the object at a relatively high discharge velocity. The invention allows a higher pressure and a simpler and more reliable coating method.

### FIELD OF THE INVENTION

The invention relates to a device and a method for spray extrusion, and more particularly for application of a surface coating from “under-up” onto car bodies. The surface coating may be a PVC abrasion protection material, a joint sealant or the like, and is generally a low-viscosity material. The invention provides a new nozzle design giving a higher pressure and a simpler and a more reliable application method.

### STATE OF THE ART

In the prior art, a slotted nozzle is used, held relatively close to the object for spraying the material upwards and coating the object. The material is sprayed towards the object in the form of a strip. As the material has a low viscosity, a relatively low velocity and a low pressure is obtained out of the nozzle. Hereby, the material will not fill up well in e.g. spot weld craters, corners and other irregularities. There is a risk of creating air pockets, thus seriously deteriorating adhesion and other functions of the coating. The low pressure also makes the jet of material to be concentrated at the centre of the slot, making the jet uneven. The low pressure further entails that the nozzle will be more sensitive to environmental variations, e.g. pressure and temperature. It may also occur, that the distance to the object will be too large and that the jet will not reach there at all.

The present invention resolves the above problems by replacing the slot with a row of holes. In this way, the nozzle will have about the same extension as the previous slot, whereas the outlet area of the nozzle will be substantially smaller. Thanks to the smaller area, the pressure inside the nozzle will increase, and a higher discharge velocity of the jet will be achieved. Hereby, the application distance between the object and the nozzle can be increased, whilst the material will still reliably hit the object. The material will fill out any irregularities in the object in a more reliable way. Through the increased pressure, the material will also be distributed more evenly across the entire spread of the nozzle.

### SUMMARY OF THE INVENTION

The present invention thus provides a device for spray extrusion, for connection to a source of coating material under pressure, comprising a nozzle for spraying the material onto an object.

According to the invention, the nozzle has a discharge opening in the form of a hole pattern, preferably a row of holes.

Through this reduction of the discharge area an increased pressure is created inside the nozzle, causing the material to be sprayed out of the nozzle onto the object at a relatively high discharge speed, achieving a relatively high degree of insensitivity to the distance between the nozzle and the object.

The invention is defined by the appended claims 1 and 6, whereas advantageous embodiments are defined in the dependent claims.

### BRIEF DESCRIPTION OF THE DRAWINGS

The invention will be described in detail below, with reference to the enclosed drawings, in which:

FIG. 1 shows a side view of a nozzle according to the present invention, and

FIG. 2 shows a view in the direction of the arrows A-A, i.e. from the front.

### DETAILED DESCRIPTION OF PREFERRED EMBODIMENTS

The invention generally relates to spraying or extrusion of so-called low-viscosity materials. The method is common e.g. in the car industry, for the application of various kinds of surface coatings onto car bodies. The surface coatings, as was mentioned previously, may be various kinds of abrasion protection materials, joint sealants and similar.

The invention is an improvement over the prior art, which had problems in filling out irregularities and corners with the coating material. The problems were a.o. caused by the coating material leaving the nozzle at too low a velocity, due to the low viscosity of the coating material and the design of the nozzle.

The present invention solves the problems by increasing the pressure inside the nozzle, so as to increase the discharge velocity from the nozzle. Thereby, the nozzle can be held further away from the object to be coated, whilst still ensuring that the coating material will hit the object at a certain minimum velocity, filling out all irregularities. Generally, the invention achieves this through providing, instead of an uninterrupted nozzle opening, a nozzle tip exhibiting a hole pattern with approximately the same extension as the prior art nozzle aperture, which was generally in the form of a slot.

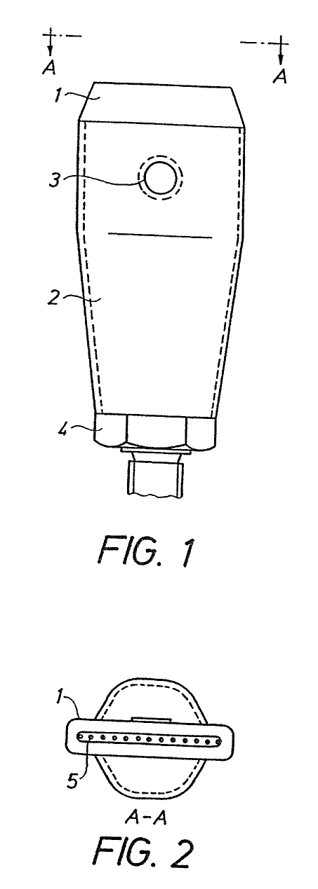

FIGS. 1 and 2 illustrate a preferred embodiment of the invention. In the figures, a nozzle is generally shown, for connection to a source (not shown) of coating material. The nozzle has a tip 1, to be directed towards the object to be treated, a body 2, containing the major part of the nozzle chamber, and a connector 4, for connection to a hose or similar, coming from the material source. The nozzle illustrated in the drawings also has a fixture 3 in the form of a through hole, used for attaching the nozzle to a robot or the like. The fixture 3 does not otherwise affect the function of the nozzle.

As can be seen in FIG. 2, the nozzle has a discharge aperture consisting of a hole pattern, in this case a row of holes 5, debouching into the front surface of the nozzle. According to the prior art, the corresponding nozzle would have an uninterrupted slot (not shown) with the same extension, at least width, as the hole pattern according to the invention. It should be evident that the discharge area of a nozzle according to the invention is substantially reduced in comparison with the prior art. The number of holes and their individual areas will vary in dependence of the material used. Also suitable pressures and discharge velocities will be dependent on the coating material and the specific application. By way of example, the total discharge area of the nozzle may lie within 10-20% of a corresponding, uninterrupted discharge opening according to the prior art. The nozzle will advantageously be made of stainless steel.

With the aid of the nozzle according to the invention, a high discharge velocity of the material will be achieved. A separate string will be discharged from each hole 5. It is especially advantageous if the strings of material are not joined in the air into the conventional, strip-like shape, before the strings hit the object. In this way, any air trapped between the material and the object will be avoided. As the strings hit the object, they will fuse together into a flat, continuous strip of material, as desired. The method could be said to be a cross between spraying and extrusion. The high discharge velocity makes the jet hit the object reliably also if the application distance is increased, compared to the prior art. It is possible to use any application angle, also straight from below (under-up), thanks to the high discharge velocity. The increased pressure inside the nozzle also results in the material reliably filling out the entire width of the jet, achieving a more even coating.

A person skilled in the art will realise that the nozzle may be varied in many ways without departing from the scope of the invention. The exterior shape of the nozzle, its connections, etc., may be varied without influencing the functional principle of the nozzle. The invention is only limited by the following claims.

1. Device for spray extrusion, for connection to a source of coating material under pressure, comprising a nozzle for spraying the material onto an object, characterised in that the nozzle has a discharge aperture in the form of a pattern of holes (5), debouching into the front surface of the nozzle, said holes (5) being arranged to cause the coating material to be discharged from the nozzle in separate strings from each hole (5).

2. Device according to claim 1, characterised in that said holes (5) are arranged in a row.

3. Device according to claims 1 or 2, characterised in that the discharge aperture has a discharge area equal to about 10-20% of a corresponding uninterrupted discharge aperture.

4. Device according to any one of the preceding claims, characterised in that said holes (5) are circular.

5. Method for spray extrusion by means of a pressurised source of coating material connected to a nozzle for spraying the material onto an object, characterised in that a raised pressure is created in the nozzle by means of a discharge aperture in the form of a pattern of holes (5),
causing the material to be to be discharged from the nozzle in separate strings from each hole (5) with a relatively high discharge velocity
whereby the material strings will hit the object individually, to subsequently fuse together thereon into a flat, continuous strip of material.

6. Method according to claims 5, characterised in that said holes (5) are arranged in a row.

7. Method according to claims 5 or 6, characterised in that the discharge aperture has a discharge area equal to about 10-20% of a corresponding uninterrupted discharge aperture.

8. Method according to any one of the preceding claims 5 to 7, characterised in that said holes (5) are circular.
